(19) United States
(12) Patent Application Publication
(10) Pub. No.: US 2024/0172137 A1
(43) Pub. Date: May 23, 2024

(54) A METHOD TO LIMIT TX TRANSMIT POWER FOR FDD HPUE

(71) Applicant: QUALCOMM Incorporated, San Diego, CA (US)

(72) Inventors: Bin HAN, Beijing (CN); Valentin Alexandru GHEORGHIU, Yokohama-shi (JP); Marco PAPALEO, Bologna (IT); Ting WANG, Beijing (CN); Gene FONG, San Diego, CA (US); Ryan Scott Castro SPRING, San Diego, CA (US); Yiqing CAO, Beijing (CN)

(21) Appl. No.: 18/284,406

(22) PCT Filed: May 11, 2021
(86) PCT No.: PCT/CN2021/093035

§ 371 Date: Sep. 27, 2023

(51) Int. Cl. H04W 52/36; H04W 52/24

(52) U.S. Cl. CPC H04W 52/367; H04W 52/243

(57) ABSTRACT

A user equipment may be configured to limiting transmit power for frequency domain division for high power user equipment. In some aspects, the user equipment may determine a UE context is interference limited or noise limited based on comparing a measurement value to a threshold value, set a maximum transmit power based on the UE context, and transmit, during a time period associated with a downlink (DL) grant, an uplink (UL) transmission at the maximum transmit power.

### BACKGROUND

### Technical Field

The present disclosure relates generally to wireless communication, and more particularly, to limiting transmit (TX) power for frequency domain division (FDD) for high power user equipment (HPUE).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example implementation includes a method of wireless communication at a user equipment (UE) comprising determining whether a UE context is interference limited or noise limited based on comparing a measurement value to a threshold value; setting a maximum transmit power based on the UE context; and transmitting, during a time period associated with a downlink (DL) grant, an uplink (UL) transmission at the maximum transmit power.

The disclosure also provides an apparatus (e.g., a UE) including a memory storing computer-executable instructions and at least one processor configured to execute the computer-executable instructions to determine a UE context is interference limited or noise limited based on comparing a measurement value to a threshold value; set a maximum transmit power based on the UE context; and transmit, during a time period associated with a downlink (DL) grant, an uplink (UL) transmission at the maximum transmit power. In addition, the disclosure also provides an apparatus including means for performing the above method, and a computer-readable medium (e.g., a non-transitory computer-readable medium) storing computer-executable instructions for performing the above method.

An example implementation includes a method of wireless communication at a base station comprising receiving, from a user equipment (UE) reporting information indicating setting of a maximum transmit power based on a UE context; and modifying, based on the receiving, one or more scheduling parameters associated with a DL grant allocated to the UE.

The disclosure also provides an apparatus (e.g., a base station) including a memory storing computer-executable instructions and at least one processor configured to execute the computer-executable instructions to receive, from a user equipment (UE) reporting information indicating setting of a maximum transmit power based on a UE context; and modify, based on the receiving, one or more scheduling parameters associated with a DL allocated to the UE. In addition, the disclosure also provides an apparatus including means for performing the above method, and a computer-readable medium (e.g., a non-transitory computer-readable medium) storing computer-executable instructions for performing the above method.

To the accomplishment of the foregoing and related ends, the one or more aspects include the features hereinafter fully described and particularly pointed out in the claims. The following description and the annexed drawings set forth in detail some illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with some aspects of the present disclosure.

FIG. 2A is a diagram illustrating an example of a first 5G/NR frame, in accordance with some aspects of the present disclosure.

FIG. 2B is a diagram illustrating an example of DL channels within a 5G/NR subframe, in accordance with some aspects of the present disclosure.

FIG. 2C is a diagram illustrating an example of a second 5G/NR frame, in accordance with some aspects of the present disclosure.

FIG. 2D is a diagram illustrating an example of UL channels within a 5G/NR subframe, in accordance with some aspects of the present disclosure.

FIG. 3 is a diagram illustrating an example of a base station and a UE in an access network, in accordance with some aspects of the present disclosure.

FIG. 4 is a diagram illustrating example communications and components of a base station and UEs, in accordance with some aspects of the present disclosure.

FIG. 5 is a diagram illustrating an example of a hardware implementation for a base station employing a processing system, in accordance with some aspects of the present disclosure.

FIG. 6 is a diagram illustrating an example of a hardware implementation for a UE employing a processing system, in accordance with some aspects of the present disclosure.

FIG. 7 is a flowchart of an example method of limiting TX power for FDD for HPUE at a base station, in accordance with some aspects of the present disclosure.

FIG. 8 is a flowchart of an example method of limiting TX power for FDD for HPUE at a UE, in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to a person having ordinary skill in the art that these concepts may be practiced without these specific details. In some instances, structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, among other examples (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, among other examples, whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Various implementations relate generally to a procedure for limiting TX power for FDD for HPUE. As used herein, “HPUE” may refer to an operating mode of a UE where a maximum transmit power of the UE is increased from above the power class 3 (PC3) maximum power level (e.g., 23 dBm). In some aspects, a UE may attempt to employ FDD HPUE. As such, the UE may determine a context of the UE. For example, the UE may determine whether the interference environment of the UE is limited primarily by interference or by noise. In some aspects, the UE may identify the interference environment by comparing one or more measurement values (e.g., a received signal strength indicator (RSSI) measurement, etc.) to a threshold value. Further, the UE may adjust the maximum transmit power based upon the context of the UE. For instance, the UE may limit and/or adjust the maximum transmit power of the UE during a scheduled DL transmission when the context of the UE indicates that the interference environment is limited primarily by noise. In some other instances, the UE may adjust and/or set the maximum transmit power of the UE during a scheduled DL transmission when the context of the UE indicates that the interference environment is limited primarily by interference. Accordingly, the present techniques disclose implementing FDD HPUE without negatively impacting DL performance, thereby improving cell coverage and user experience.

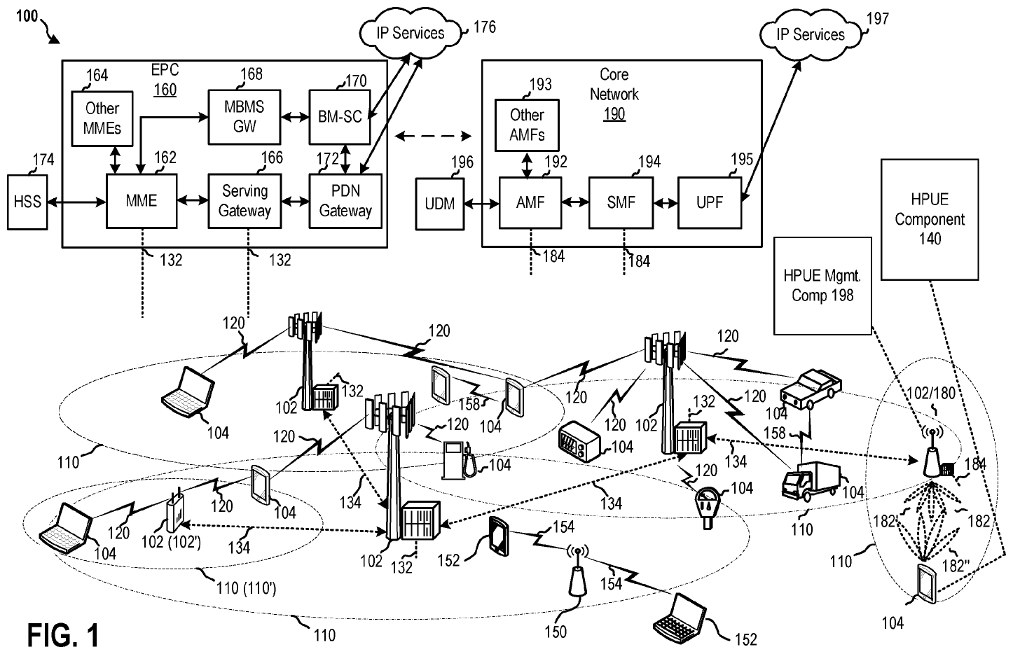

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (for example, a 5G Core (5GC)). The base stations 102 may include macrocells (high power cellular base station) or small cells (low power cellular base station). The macrocells include base stations. The small cells include femtocells, picocells, and microcells.

In an aspect, a base station 102 may include a HPUE management component 198 configured to manage utilization of HPUE at one or more UEs 104. For example, the HPUE management component 198 may transmit signaling to the UEs indicating that the UEs are permitted to employ HPUE and limit transmit power when employing HPUE in specific contexts, as described in detail herein. Further, the HPUE management component 198 may receive reporting information from one or more UEs 104 indicating that the one or more UEs 104 are employing HPUE, and modify scheduling parameters used for scheduling DL transmissions to the UEs 104 to account for HPUE usage at the UEs 104.

Further, a UE 104 may include a HPUE component 140 configured to adjust and/or limit transmit power during application of HPUE. In particular, the HPUE component 140 may compare a measurement value to a predefined threshold to determine a UE context. In some aspects, the UE context may be interference limited or noise limited. As used herein, in some aspects, an “interference limited” context may refer to a context in which UE received interference due inter or intra cell is dominant. As used herein, in some aspects, a “noise limited” context may refer to a context in which thermal noise is dominant. Further, the HPUE component 140 may adjust and/or limit the maximum transmit power of the UE 104 based on the UE context. For example, in the noise limited context, the HPUE component 140 may limit the maximum transmit power during scheduled DL transmissions. In some aspects, the HPUE component 140 may adjust and/or limit the maximum transmit power based on signaling received from the base station 102. Additionally, or alternatively, in some aspects, the HPUE component 140 may trigger reporting to the base station 102 indicating that the HPUE component 140 is adjusting and/or limiting the maximum transmit power.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (for example, an S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (for example, handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (for example, through the EPC 160 or core network 190) with each other over third backhaul links 134 (for example, X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102a may have a coverage area 110a that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 or downlink (DL) (also referred to as forward link) transmissions from a base station 102 to a UE 104. The communication links 120 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (for example, 5, 10, 15, 20, 100, 400 MHz, among other examples) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (for example, more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102a may operate in a licensed or an unlicensed frequency spectrum. When operating in an unlicensed frequency spectrum, the small cell 102a may employ NR and use the same 5 GHz unlicensed frequency spectrum as used by the Wi-Fi AP 150. The small cell 102a, employing NR in an unlicensed frequency spectrum, may boost coverage to or increase capacity of the access network.

A base station 102, whether a small cell 102a or a large cell (for example, macro base station), may include or be referred to as an eNB, gNodeB (gNB), or another type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5GNR two initial operating bands have been identified as frequency range designations FR1 (416 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range. The base station 180 and the UE 104 may each include a plurality of antennas, such as antenna elements, antenna panels, or antenna arrays to facilitate the beamforming.

The base station 180 may transmit a beamformed signal to the UE 104 in one or more transmit directions 182a. The UE 104 may receive the beamformed signal from the base station 180 in one or more receive directions 182b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a satellite phone, a cellular phone, a smart phone, a session initiation protocol (SIP) phone, a laptop, a personal digital assistant (PDA), a satellite radio, a global positioning system, a multimedia device, a video device, a digital audio player (for example, MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (for example, parking meter, gas pump, toaster, vehicles, heart monitor, among other examples). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies.

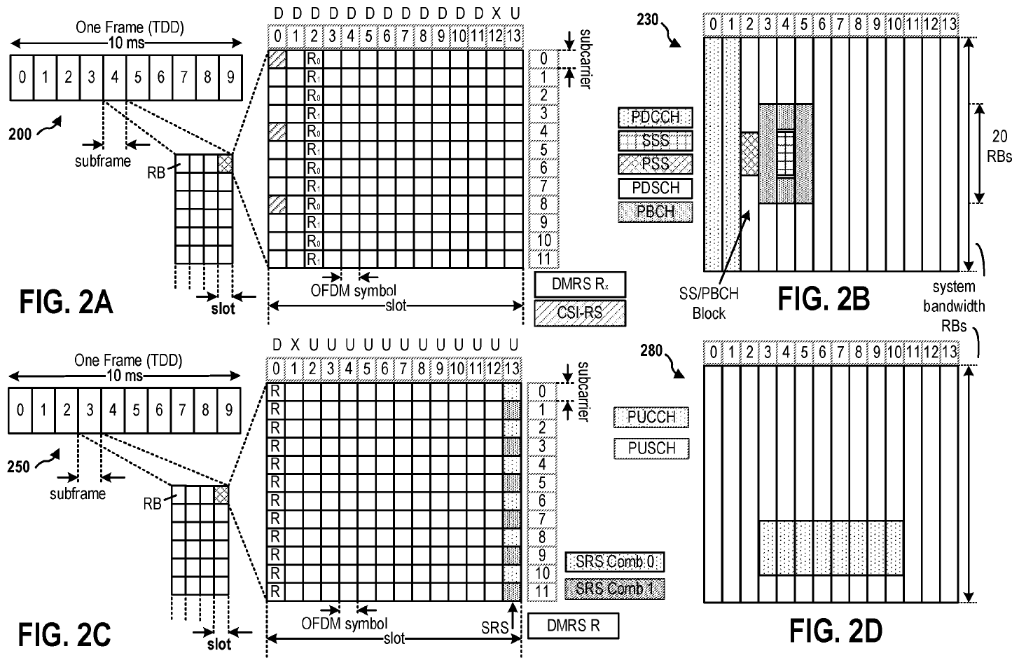

FIGS. 2A-2D include example diagrams 200, 230, 250, and 280 illustrating examples structures that may be used for wireless communication by the base station 102 and the UE 104, e.g., for 5G NR communication. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description presented herein applies also to a 5G/NR frame structure that is TDD.

Other wireless communication technologies may have a different frame structure or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. For slot configuration 0 and numerology μ, there are 14 symbols/slot and 2μ slots/subframe. The subcarrier spacing and symbol length/duration are a function of the numerology. The subcarrier spacing may be equal to 2*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more CCE, each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

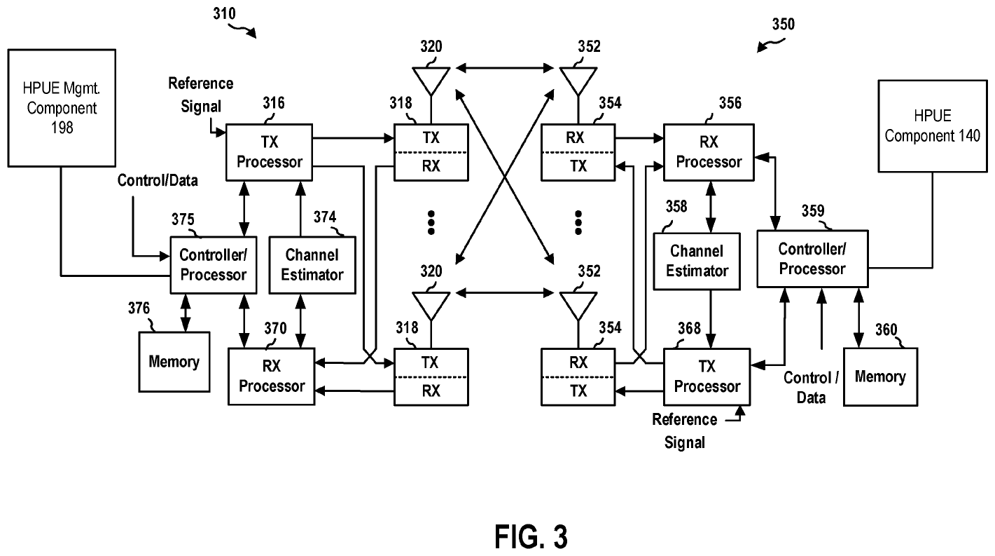

FIG. 3 is a block diagram of a base station 102/180 in communication with a UE 104 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (such as a pilot) in the time or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102/180. These soft decisions may be based on channel estimates computed by the channel estimator 358. The soft decisions are then decoded and deinterleaved to recover the data and control signals that were originally transmitted by the base station 102/180 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102/180, the controller/processor 359 provides RRC layer functionality associated with system information (for example, MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102/180 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102/180 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

In the UE 104, at least one of the TX processor 368, the RX processor 356, and the controller/processor 359 may be configured to perform aspects in connection with the HPUE component 140 of FIG. 1.

In the base station 102/180, at least one of the TX processor 316, the RX processor 370, and the controller/processor 375 may be configured to perform aspects in connection with HPUE management component 198 of FIG. 1.

Employing HPUE allows a UE to increase transmit power, which can extend cell coverage and improve user experience via increased reliability. For example, UEs applying HPUE may utilize a maximum transmit power of 26 dBm (i.e., power class 2), while UEs not applying HPUE may only utilize a maximum transmit power of 23 dBm (i.e., power class 3). As used herein, the term “dBm” refers to an absolute value of power, and the term “dB” refers to a ratio of powers. Some systems currently employ HPUE in TDD systems where DL reception and UL transmission are not contemporaneous and the higher transmission power of HPUE will not negatively affect DL performance. In particular, because the DL reception and UL transmission are not contemporaneous, the higher transmission power will not cause de-sense at the UE, i.e., degrade the receiver sensitivity of the UE. However, DL reception and UL transmission are contemporaneous in FDD systems. In some aspects, the following factors have an impact on the level of de-sense in FDD HPUE: UL and DL duplexer isolation, interference environment, UL configuration (e.g., UL RB allocation, UL channel bandwidth, etc.), and/or UL power level, which depends on UE location and power control mechanism. Consequently, the inability to manage de-sense at higher transmit power levels has prevented usage of HPUE in real-world FDD systems.

The present disclosure provides techniques for adjusting and/or limiting TX power for FDD for HPUE. As described above, DL performance degradation results from using HPUE in FDD systems. Accordingly, the present techniques adjust and/or limit a maximum transmit power of UE employing HPUE, thereby preventing de-sense while improving cell coverage.

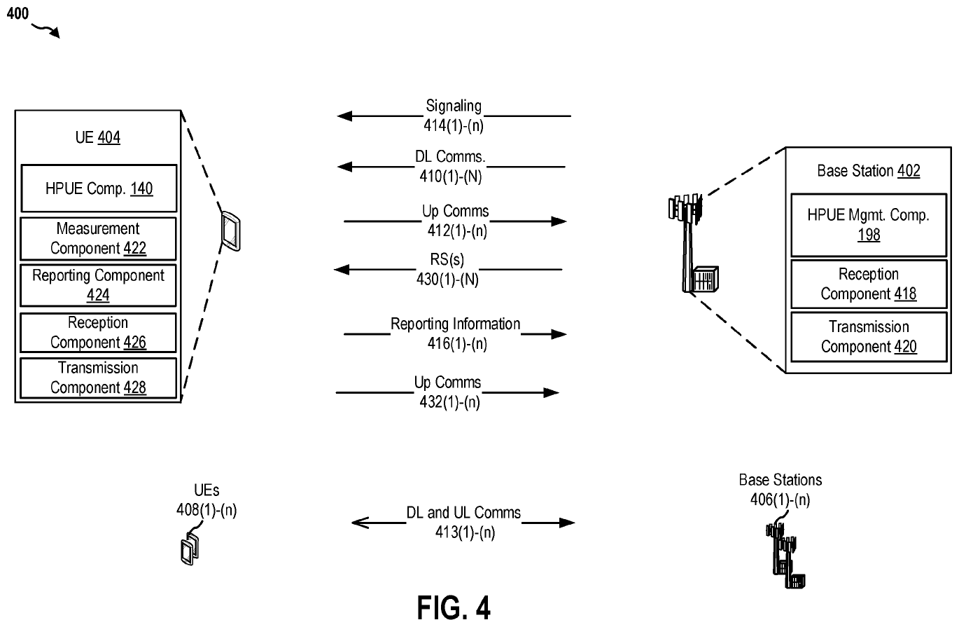

The method of adjusting and/or limiting TX power for FDD for HPUE is further described below with reference to FIGS. 4-8.

FIG. 4 is a diagram illustrating example communications and components of base stations and UEs. As illustrated in FIG. 4, the system 400 may include a base station 402 (e.g., the base station 102/180) serving at least a UE 404 (e.g., the UE 104). Further, the system 400 may include one or more other base stations 406 and one or more other UEs 408 configured to perform similar operations as the base station 402 and the UE 404, respectively. Further, the base station 402 and the UE 404 may be configured for beamformed wireless communications. For example, the base station 402 may transmit DL transmissions 410 to the UE 404 and receive UL transmissions 412 from the UE 404. Additionally, the other base stations 406 and the other UEs 408 may communicate with the base station 402, the UE 404, and/or be within close proximity of the base station 402 and/or the UE 404. For example, the base stations 402 and 406 may exchange DL and UL transmissions 413 with the UEs 408. In some instances, the DL and UL transmissions 413 may cause interference at the UE 404.

As illustrated in FIG. 4, the base station 402 may include the HPUE management component 198 configured to manage use of HPUE at the UEs 404 and 408. In particular, the HPUE management component 198 may transmit signaling information enabling or disabling HPUE with UE-controlled limiting of the maximum transmit power at the UEs 404 and 408. For example, the HPUE management component 198 may be configured to transmit signaling 414 to the UE 404 indicating that the UE 404 is permitted to perform HPUE and limit the maximum transmit power. As another example, the HPUE management component 198 may broadcast the signaling 414 to all UEs 404 and 408 of a cell of the base station 402 to perform HPUE and limit the maximum transmit power. In some aspects, the signaling may be 1 bit signaling, e.g., RRC signaling.

Further, the HPUE management component 198 may be configured to receive reporting information 416, from the UEs 404 and 408, indicating the performance of HPUE at the UEs 404 and 408. For example, the base station 402 may receive reporting information 416(1) from the UE 404 indicating that the UE 404 is performing HPUE. In response, in some aspects, the base station 402 may interact with the UE 404 as if the UE 404 is a PC2 device. Additionally, or alternatively, in some aspects, the base station 402 may adjust one or more scheduling parameters associated with the UE 404 in response to receiving the reporting information 416(1) indicating that the UE 404 is performing HPUE. For example, the base station 402 may modify k0 values communicated through the PDCCH to schedule UL and DL grants at different times, which can prevent or reduce DL de-sense.

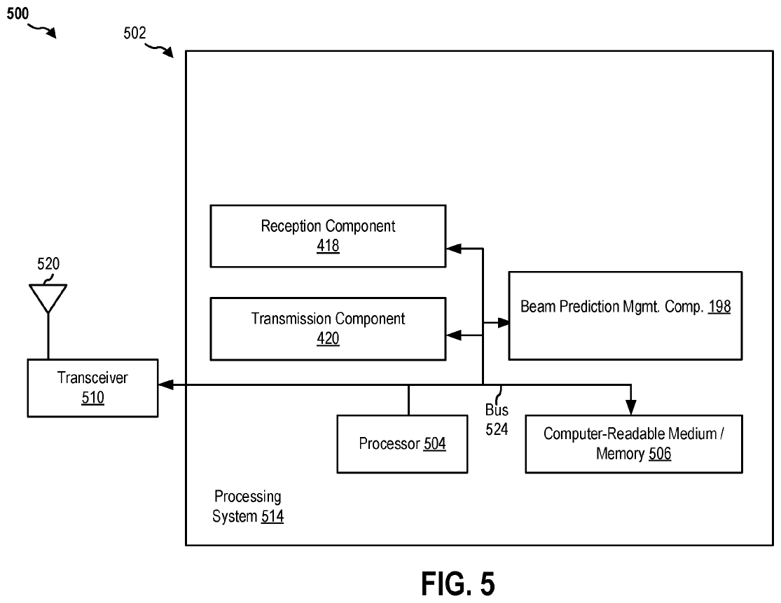

In addition, the base station 402 may include a reception component 418 and a transmission component 420. The reception component 418 may include, for example, a radio frequency (RF) receiver for receiving the signals described herein. The transmission component 420 may include, for example, an RF transmitter for transmitting the signals described herein. In an aspect, the reception component 418 and the transmission component 420 may be co-located in a transceiver (e.g., the transceiver 510 shown in FIG. 5).

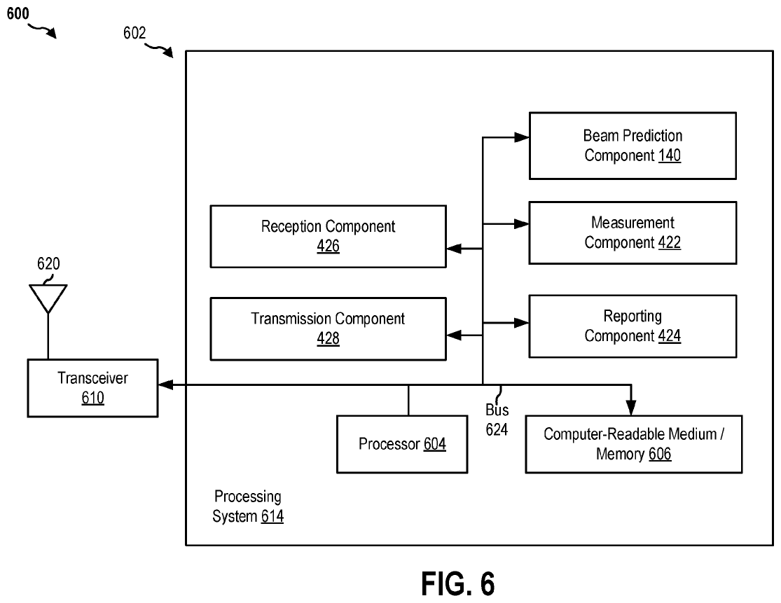

As illustrated in FIG. 4, the UE 404 may include the HPUE component 140, a measurement component 422, and a reporting component 424. In addition, the UE 404 may include a reception component 426 and a transmission component 428. The transmission component 428 may be configured to generate signals for transmission operations and sensing as described herein. The transmission component 428 may include, for example, a RF transmitter for transmitting the signals described herein. The reception component 426 may include, for example, a RF receiver for receiving the signals described herein. In an aspect, the reception component 426 and the transmission component 428 may be co-located in a transceiver (e.g., the transceiver 610 shown in FIG. 6).

The measurement component 422 may be configured to measure one or more sources to determine one or more measurement values. For example, the measurement component 422 may be configured to perform a received signal strength indicator (RSSI) measurement on power from the one or more sources to determine the measurement value. Further, the one or more sources may include the base station 402 as well as all co-channel power and other sources of noise, e.g., power generated by other components of the UE 404. As another example, the measurement value may be based on a RSSI measurement and a reference signal received power (RSRP) measurement. In particular, the measurement component 422 may measure the RSSI to determine a RSSI value, measure the RSRP of a RS 430 received from the base station 402 to determine a RSRP value, normalize the RSSI value and the RSRP value, and subtract the normalized RSRP value from the normalized RSSI value to determine the measurement value. As another example, the measurement value(s) may be based on a RSSI measurement and a signal-to-interference-plus-noise ratio (SINR) measurement. In some aspects, the measurement component 422 may measure the RSSI to determine a RSSI value (i.e., a first measurement value), measure the SINR of a RS 430 received from the base station 402 to determine a SINR value (i.e., a second measurement value), and compare the RSSI value and the SINR value to predefined thresholds as measurement values. As yet still another example, the measurement value(s) may be based on a RSSI measurement (i.e., a first measurement value) and a channel quality information (CQI) measurement (i.e., a second measurement value). In some aspects, the measurement component 422 may measure the RSSI to determine a RSSI value, measure the CQI of a RS 430 received from the base station 402 to determine a CQI value, and compare the RSSI value and SINR value to predefined thresholds as the measurement value.

Further, the HPUE component 140 may be configured to determine a UE context of the UE 404. For example, the HPUE component 140 may be configured to determine whether the UE context is interference limited or noise limited based on comparing the measurement value determined by the measurement component 422 to a threshold value. In some aspects, the HPUE component 140 may be configured to determine that the UE context is noise limited based upon the measurement value being less than the threshold value. For example, the HPUE component 140 may determine that the UE context is noise limited based on a measurement value based on an RSSI value being less than predefined threshold, and/or the difference between a RSSI value and RSRP value being less than a predefined threshold. As another example, the HPUE component 140 may be configured to determine that the UE context is noise limited based upon a RSSI measurement value being below a first predefined threshold and a SINR measurement value being below a second predefined threshold. As yet still another example, the HPUE component 140 may be configured to determine that the UE context is noise limited based upon a RSSI measurement value being below a first predefined threshold and a CQI measurement value being below a second predefined threshold. Further, the HPUE component 140 may be configured to determine that the UE context is interference limited based upon the measurement value being greater than or equal to a predefined threshold value.

Upon determining the UE context, the HPUE component 140 may determine the maximum transmit power of the transmission component 428. For example, the HPUE component 140 may be configured to set the maximum transmit power of the transmission component 428 to 26 dBm (i.e., PC2) or greater (e.g., PC1.5) when the UE context is interference limited, as the maximum TX power for PC2 has negligible DL de-sense in an interference limited context.

Additionally, the HPUE component 140 may be configured to adjust and/or reduce the maximum transmit power when the UE context is noise limited to reduce de-sense. For example, the HPUE component 140 may set the maximum transmit power to a value between 23 dBm and 26 dBm that causes a negligible amount of de-sense. In some aspects, in the noise limiting context, the HPUE component 140 may be configured to determine the maximum transmit power value based on at least one of the UL/DL duplexer isolation (e.g., FDD band definition) at the UE 404, the UL configuration UL configuration (e.g., UL RB allocation, UL channel bandwidth, etc.) of the UE 404, and/or a DL modulation scheme of the UE 404.

For example, in some aspects, the HPUE component 140 may determine a maximum transmit power as high as 26 dBm when the UE 404 has large isolation at the UL/DL duplexer, which is less likely to cause de-sense. For instance, if the isolation is greater than a predefined MHz value, the maximum transmit power may be set as 26 dBm. Otherwise, in some aspects, the maximum transmit power may be set to a value greater than or equal to 23 dBm and less than 26 dBm, or the maximum transmit power may be set to a value greater than 23 dBm and less than 26 dBm. As another example, the HPUE component 140 may determine a maximum transmit power value as high as 26 dBm when the UE 404 has small UL channel bandwidth less likely to cause de-sense. For instance, if the UL channel bandwidth is less than a predefined MHz value, the maximum transmit power may be set as 26 dBm. Otherwise, in some aspects, the maximum transmit power may be set to a value greater than or equal to 23 dBm and less than 26 dBm, or the maximum transmit power may be set to a value greater than 23 dBm and less than 26 dBm. As yet still another example, the HPUE component 140 may determine a maximum transmit power value as high as 26 dBm when the UE employs a low DL modulation scheme less likely to cause de-sense (e.g., QPSK). For instance, if the DL modulation is QPSK, the maximum transmit power can be set as 26 dBm. Otherwise, in some aspects, the maximum transmit power may be set to a value greater than or equal to 23 dBm and less than 26 dBm, or the maximum transmit power may be set to a value greater than 23 dBm and less than 26 dBm. Alternatively, the UE 404 may set the maximum transmit power to 23 dBm or a value within a range between 23 dBm and 26 dBm based on small isolation UL/DL duplexer, large UL channel bandwidth, and/or a high DL modulation scheme.

Once the HPUE component 140 determines the maximum transmit power based on the UE context, the HPUE component 140 may be configured to enforce the maximum transmit power when the UE 404 has a scheduled DL transmission 410. For example, the HPUE component 140 may determine that the UE 404 has a scheduled DL transmission 410 using a particular resource (e.g. a DL slot), and enforce the maximum transmit power at the transmission component 428 for a contemporaneous UL transmission 432. Otherwise, the transmission component 428 may transmit the UL transmissions 412 at a transmit power of 26 dBm. For instance, if the HPUE component 140 sets the maximum transmit power to 25 dBm based on determining that the UE context is noise limited and the UE 404 has large isolation at the UL/DL duplexer, the HPUE component 140 may reduce the maximum transmit power to 25 dBm during the UL transmission 432(1) that occurs contemporaneously with the DL transmission 410(1). Further, in some aspects, the HPUE component 140 may determine that the UE 404 has a scheduled DL transmission 410 that necessitates limiting the transmit power of the transmission component 428 based on decoding the PDCCH and identifying a scheduled resource allocated to the DL transmission 410 based at least in part on the value of k0.

In some aspects, the HPUE component 140 may enforce the maximum transmit power when the UE 404 has received the signaling 414 from the base station 402 indicating that the UE 404 is permitted to implement HPUE. For example, the UE 404 may operate as a PC3 device and transmit the UL transmissions 412 at a transmit power of 23 dBm. Further, the UE 404 may receive the signaling 414 from the base station 402. In response to the signaling 414, the HPUE component 140 may determine the UE context, determine the maximum transmit power (e.g., 24.5 dBm) based on the UE context, and enforce the maximum transmit power when transmitting UL transmissions 432 that occur at the same time as one or more of the DL transmissions 410. In particular, in some aspects, the HPUE component 140 may ensure the transmission component 428 transmits the UL transmissions 432 at 24.5 dBm.

In some aspects, the HPUE component 140 may not enforce the maximum transmit power based upon a status of the UL data buffer. For example, if the UL data buffer is above a predefined threshold, the HPUE component 140 may not limit the maximum transmit power even when the UL transmission 432 overlaps with a scheduled DL transmission 410. In some aspects, the HPUE component 140 may not limit the maximum transmit power even when the UL transmission 432 overlaps with a scheduled DL transmission 410 because the UL data buffer is full.

The reporting component 424 may be configured transmit reporting information 416 to the base station 402. For example, the reporting component 424 may transmit the reporting information 416(1) to the base station 402 indicating that the UE 404 is performing HPUE. As described in detail above, in response to the reporting information 416, in some aspects, the base station 402 may interact with the UE 404 as if the UE 404 is a PC2 device.

FIG. 5 is a diagram 500 illustrating an example of a hardware implementation for a base station 502 (e.g., the base station 102/180, the base station 402, etc.) employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the HPUE management component 198, and the computer-readable medium/memory 506. The bus 524 may also link various other circuits such as timing sources, peripherals, voltage regulators, and power management circuits, which are well known in the art, and therefore, will not be described any further.

The processing system 514 may be coupled with a transceiver 510. The transceiver 510 is coupled with one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 418. The reception component 418 may receive the UL transmissions 412, the reporting information 416, and/or the UL transmissions 432. In addition, the transceiver 510 receives information from the processing system 514, specifically the transmission component 420, and based on the received information, generates a signal to be applied to the one or more antennas 520. Further, the transmission component 420 may send the DL transmissions 410, the signaling 414, and/or the RSs 430(1)-(n) used by the UEs to determine the measurement values.

The processing system 514 includes a processor 504 coupled with a computer-readable medium/memory 506 (e.g., a non-transitory computer readable medium). The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes the HPUE management component 198. The aforementioned components may be software components running in the processor 504, resident/stored in the computer readable medium/memory 506, one or more hardware components coupled with the processor 504, or some combination thereof. The processing system 514 may be a component of the base station 310 and may include the memory 376 and/or at least one of the TX processor 316, the RX processor 370, and the controller/processor 375. Alternatively, the processing system 514 may be the entire base station (e.g., see 310 of FIG. 3, 402 of FIG. 4).

The aforementioned means may be one or more of the aforementioned components of the base station 502 and/or the processing system 514 of the base station 502 configured to perform the functions recited by the aforementioned means. As described supra, the processing system 514 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

FIG. 6 is a diagram 600 illustrating an example of a hardware implementation for a UE 602 (e.g., the UE 104, the UE 404, etc.) employing a processing system 614. The processing system 614 may be implemented with a bus architecture, represented generally by the bus 624. The bus 624 may include any number of interconnecting buses and/or bridges depending on the specific application of the processing system 614 and the overall design constraints. The bus 624 links together various circuits including one or more processors and/or hardware components, represented by the processor 604, the HPUE component 140, the measurement component 422, the reporting component 424, and the computer-readable medium (e.g., non-transitory computer-readable medium)/memory 606. The bus 624 may also link various other circuits such as timing sources, peripherals, voltage regulators, and power management circuits, which are well known in the art, and therefore, will not be described any further.

The processing system 614 may be coupled with a transceiver 610. The transceiver 610 may be coupled with one or more antennas 620. The transceiver 610 provides a means for communicating with various other apparatus over a transmission medium. The transceiver 610 receives a signal from the one or more antennas, extracts information from the received signal, and provides the extracted information to the processing system 614, specifically the reception component 426. The reception component 426 may receive the DL transmissions 410, and/or the signaling 414. In addition, the transceiver 610 receives information from the processing system 614, specifically the transmitter component 428, and based on the received information, generates a signal to be applied to the one or more antennas. Further, the transmitter component 428 may transmit the UL transmissions 412, the reporting information 416, and/or the UL transmissions 432. Further, as described in detail herein, the transmission component 428 may transmit the UL transmissions 432 at a maximum transmit power set by the HPUE component 140 based on a UE context.

The processing system 614 includes a processor 604 coupled with a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the HPUE component 140, the measurement component 422, and the reporting component 424. The component may be a software component running in the processor 604, resident/stored in the computer readable medium/memory 606, one or more hardware components coupled with the processor 604, or some combination thereof. The processing system 614 may be a component of the UE 350 and may include the memory 360 and/or at least one of the TX processor 368, the RX processor 356, and the controller/processor 359. Alternatively, the processing system 614 may be the entire UE (e.g., see 350 of FIG. 3).

The aforementioned means may be one or more of the aforementioned components of the UE 602 and/or the processing system 614 of UE 602 configured to perform the functions recited by the aforementioned means. As described supra, the processing system 614 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

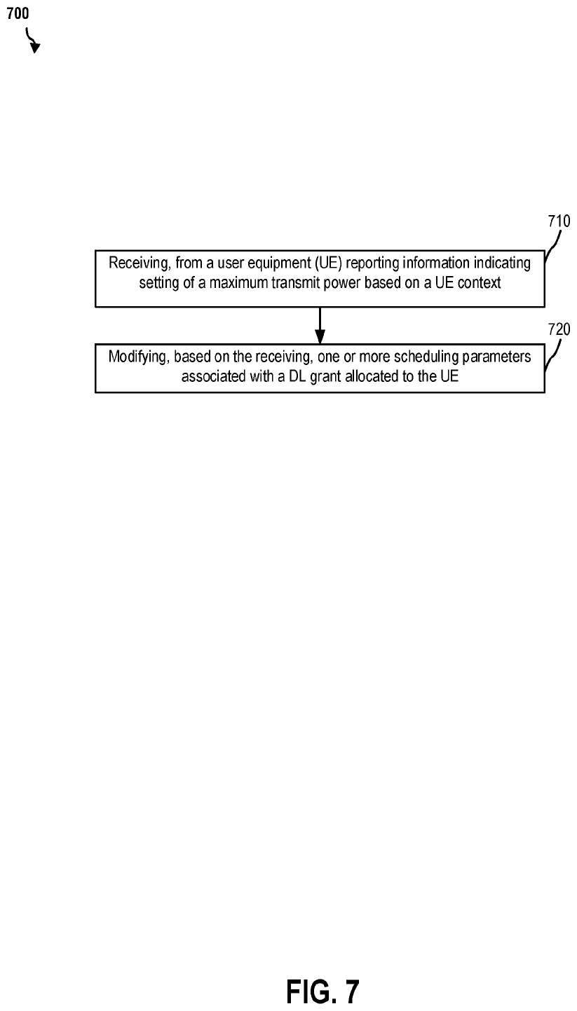

FIG. 7 is a flowchart of a method 700 for limiting TX power for FDD for HPUE, in accordance with some aspects of the present disclosure. The method may be performed by a base station (e.g., the base station 102, which may include the memory 376 and which may be the entire base station or a component of the base station, such as HPUE management component 198, the TX processor 316, the RX processor 370, and/or the controller/processor 375; the base station 402, the base station 502 of FIG. 5).

At block 710, the method 700 may include receiving, from a user equipment (UE) reporting information indicating setting of a maximum transmit power based on a UE context. For example, the base station 402 may receive the reporting information 416 from the UE 404. Accordingly, the base station 102, the base station 402, the base station 502, the TX processor 316, the RX processor 370, and/or the controller/processor 375 executing the HPUE management component 198 may provide means for receiving, from a user equipment (UE) reporting information indicating setting of the maximum transmit power based on a UE context.

At block 720, the method 700 may include modifying, based on the receiving, one or more scheduling parameters associated with a DL grant allocated to the UE. For example, the base station 402 may modify k0 values communicated through the PDCHH to schedule UL and DL grants at different times.

Accordingly, the base station 102, the base station 402, the base station 502, the RX processor 370, and/or the controller/processor 375 executing the HPUE management component 198 may provide means modifying, based on the receiving, one or more scheduling parameters associated with a DL grant allocated to the UE.

In an additional aspect, the method 700 further comprises transmitting, to a second UE, signaling enabling limiting of the maximum transmit power based on a UE context. For example, the HPUE management component 198 may transmit the signaling 414 to the UE 404 instructing the UE 404 to employ HPUE and limit the maximum transmit power based on UE context. Accordingly, the base station 102, the base station 402, the base station 502, the TX processor 316, the RX processor 370, and/or the controller/processor 375 executing the HPUE management component 198 may provide means for transmitting, to a second UE, signaling enabling limiting of the maximum transmit power based on a UE context.

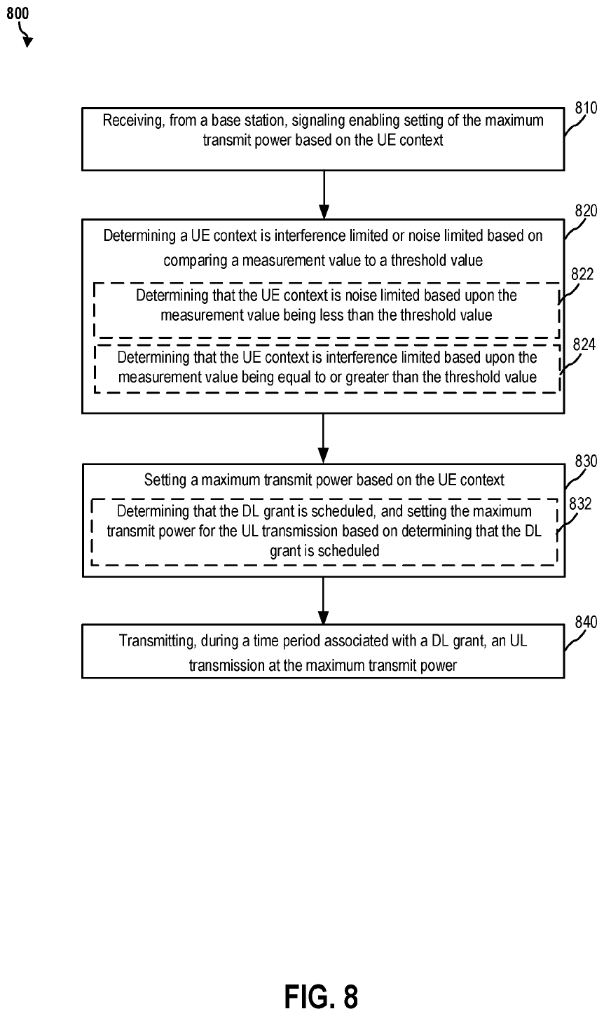

FIG. 8 is a flowchart of a method 800 for limiting TX power for FDD for HPUE, in accordance with some aspects of the present disclosure. The method may be performed by a UE (e.g., the UE 104 of FIGS. 1 and 3, which may include the memory 360 and which may be the entire UE 104 or a component of the UE 104, such as HPUE component 140, the TX processor 368, the RX processor 356, and/or the controller/processor 359; the UE 404 of FIG. 4; and/or the UE 602 of FIG. 6).

At block 810, the method 800 may optionally include receiving, from a base station, signaling enabling setting of the maximum transmit power based on the UE context. For example, the UE 404 may receive the signaling 414 from the base station. Further, the UE 404 may employ HPUE, and reduce the maximum transmit power based on receipt of the signaling 414. Accordingly, the UE 104, the UE 404, UE 902, the TX processor 368, the RX processor 356, and/or the controller/processor 359 executing the HPUE component 140 may provide means for receiving, from a base station, signaling enabling setting of the maximum transmit power based on the UE context.

At block 820, the method 800 may include determining whether a UE context is interference limited or noise limited based on comparing a measurement value to a threshold value. For example, the HPUE component 140 may be configured to determine whether the UE context is interference limited or noise limited based on comparing the measurement value determined by the measurement component 422 to a threshold value. In some aspects, the measurement component 422 may be determine the measurement value based at least in part on one of a RSSI measurement value, a RSRP measurement value, a SINR measurement value, and/or a SINR measurement value.

At sub-block 822, the block 820 may optionally include determining that the UE context is noise limited based upon the measurement value being less than the threshold value. In some aspects, the HPUE component 140 may be configured to determine that the UE context is noise limited based upon the measurement value being less than the threshold value. For example, the HPUE component 140 may determine that the UE context is noise limited based on a measurement value based on an RSSI value being less than predefined threshold, and/or the difference between a RSSI value and RSRP value being less than a predefined threshold.

At sub-block 824, the block 820 may optionally include determining that the UE context is interference limited based upon the measurement value being equal to or greater than the threshold value. For example, the HPUE component 140 may be configured to determine that the UE context is interference limited based upon the measurement value being greater than or equal to a predefined threshold value.

Accordingly, the UE 104, the UE 404, UE 902, the TX processor 368, the RX processor 356, and/or the controller/processor 359 executing the measurement component 422 and HPUE component 140 may provide means for determining whether a UE context is interference limited or noise limited based on comparing a measurement value to a threshold value.

At block 830, the method 800 includes setting a maximum transmit power based on the UE context. For example, the HPUE component may set the maximum transmit power for a UL transmission 432 to 25 dBm based upon the UE context being noise limited.

At sub-block 832, the block 830 may optionally include determining that the DL grant is scheduled, and setting the maximum transmit power for the UL transmission based on determining that the DL grant is scheduled. For example, the HPUE component 140 may be configured to determine that the DL transmission 410 is scheduled to occur contemporaneously with the transmission of the UL transmission 432(1) based on decoding the PDSCH, and set the maximum transmit power during the transmission of the UL transmission 432(1) to 25 dBm.

Accordingly, the UE 104, the UE 404, UE 902, the TX processor 368, the RX processor 356, and/or the controller/processor 359 executing the HPUE component 140 may provide means for setting a maximum transmit power based on the UE context.

At block 840, the method 800 may transmitting, during a time period associated with a DL grant, an UL transmission at the maximum transmit power. For example, the transmission component may transmit the UL transmission 432(1) at 25 dBm using a resource scheduled contemporaneously with a resource used for the DL transmission 410(1).

Accordingly, the UE 104, the UE 404, UE 902, the TX processor 368, the RX processor 356, and/or the controller/processor 359 executing the HPUE component 140 may provide means for may transmitting, during a time period associated with a DL grant, an UL transmission at the maximum transmit power.

In an additional or alternative aspect, wherein DL grant is a first DL grant, the UL transmission is a first UL transmission, and the method 800 further comprises determining that a UL data buffer is above a threshold value, and transmitting, based on determining the UL data buffer is above the threshold value, a second UL transmission at a power value greater than the maximum transmit power. For example, if the UL data buffer is above a predefined threshold, the HPUE component 140 may not limit the maximum transmit power for transmission of the UL transmission 432(2) even when the UL transmission 432(2) is scheduled to overlap with the DL transmission 410. Accordingly, the UE 104, the UE 404, UE 502, the TX processor 368, the RX processor 356, and/or the controller/processor 359 executing the HPUE component 140 may provide means for determining that a UL data buffer is above a threshold value and transmitting, based on determining the UL data buffer is above the threshold value, a second UL at a power value greater than the maximum transmit power. As a result, the UE 404 may prioritize transmitting UL data when the data buffer is full to avoid congestion and information loss.

In an additional or alternative aspect, the method 800 further comprises transmitting reporting information indicating setting of the maximum transmit power based on the UE context. For example, the reporting component 424 may transmit the reporting information 416 to the base station 402 indicating that the UE 404 is performing HPUE and limiting the maximum transmit power based on the UE context. Accordingly, the UE 104, the UE 404, UE 502, the TX processor 368, the RX processor 356, and/or the controller/processor 359 executing the HPUE component 140 may provide means for transmitting reporting information indicating setting of the maximum transmit power based on the UE context.

The specific order or hierarchy of blocks in the processes/flowcharts disclosed is an illustration of example approaches. Based upon design preferences, the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person having ordinary skill in the art to practice the various aspects described herein. Various modifications to these aspects will be readily apparent to a person having ordinary skill in the art, and the generic principles defined herein may be applied to other aspects. The claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Combinations such as “at least one of A, B, or C,” “one or more of A, B, or C,” “at least one of A, B. and C,” “one or more of A, B, and C,” and “A, B, C, or any combination thereof” include any combination of A, B, or C, and may include multiples of A, multiples of B, or multiples of C. Specifically, combinations such as “at least one of A, B, or C,” “one or more of A, B, or C,” “at least one of A. B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to a person having ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Clauses

A. A method of wireless communication at a UE, comprising: determining whether a UE context is interference limited or noise limited based on comparing a measurement value to a threshold value, setting a maximum transmit power based on the UE context, and transmitting, during a time period associated with a downlink (DL) grant, an uplink (UL) transmission at the maximum transmit power.
B. The method as paragraph A recites, wherein determining the UE context is interference limited or noise limited based on comparing the measurement value to the threshold value, comprises determining that the UE context is noise limited based upon the measurement value being less than the threshold value.
C. The method as paragraph B recites, wherein setting the maximum transmit power based on the UE context, comprises: determining the maximum transmit power based at least in part on UL and DL duplexer isolation of the UE.
D. The method as paragraph B recites, wherein setting the maximum transmit power based on the UE context, comprises: determining the maximum transmit power based at least in part on UL configuration information associated with the UE.
E. The method as paragraph B recites, wherein setting the maximum transmit power based on the UE context, comprises: determining the maximum transmit power based at least in part on an UL channel bandwidth of the UE.
F. The method as paragraph B recites, wherein setting the maximum transmit power based on the UE context, comprises: determining the maximum transmit power based at least in part on a DL modulation scheme of the UE.
G. The method as paragraph B recites, wherein the maximum transmit power is equal to or greater than 23 dBm.
H. The method as paragraph A recites, wherein determining the UE context is interference limited or noise limited based on comparing the measurement value to the threshold value, comprises determining that the UE context is interference limited based upon the measurement value being equal to or greater than the threshold value.
I. The method as paragraph H recites, wherein setting the maximum transmit power based on the UE context, comprises setting the maximum transmit power to a maximum value for power class two (PC2) or greater.
J. The method as paragraph H recites, wherein setting the maximum transmit power based on the UE context, comprises setting the maximum transmit power to at least 26 dBm.
K. The method as any of paragraphs A-H recite, wherein determining the UE context is interference limited or noise limited based on comparing the measurement value to the threshold value, comprises performing a received signal strength indicator (RSST) measurement to determine the measurement value.
L. The method as any of paragraphs A-H recite, wherein determining the UE context is interference limited or noise limited based on comparing the measurement value to the threshold value, comprises performing received signal strength indicator (RSSI) and reference signal received power (RSRP) measurements and combining the RSSI and RSRP measurements to determine the measurement value.
M. The method as any of paragraphs A-H recite, wherein the threshold value is a first threshold value, the measurement value is a first measurement value, and determining the UE context is interference limited or noise limited based on comparing the measurement value to the threshold value, comprises performing a received signal strength indicator (RSSI) measurement to determine the first measurement value, performing a signal-to-interference-plus-noise ratio (SINR) measurement to determine a second measurement value, comparing the first measurement value to the first threshold, and comparing the second measurement value to a second threshold.
N. The method as any of paragraphs A-H recite, wherein the threshold value is a first threshold value, the measurement value is a first measurement value, and determining the UE context is interference limited or noise limited based on comparing the measurement value to the threshold value, comprises performing a received signal strength indicator (RSSI) measurement to determine the first measurement value, performing a channel quality information (CQI) measurement to determine a second measurement value, comparing the first measurement value to the first threshold, and comparing the second measurement value to a second threshold.
O. The method as any of paragraphs A-N recite, wherein setting the maximum transmit power based on the UE context comprises: determining that the DL grant is scheduled, and setting the maximum transmit power for the UL transmission based on determining that the DL grant is scheduled.
P. The method as any of paragraphs A-O recite, wherein the UL transmission is a first UL transmission, and the method further comprising determining that a UL data buffer is above a threshold value, and transmitting, based on determining the UL data buffer is above the threshold value, a second UL transmission at a power value greater than the maximum transmit power.
Q. The method as any of paragraphs A-P recite, the method further comprising receiving, from a base station, signaling enabling setting of the maximum transmit power based on the UE context.
R. The method as any of paragraphs A-Q recite, the method further comprising: determining that a UL data buffer is above a threshold value, and transmitting, based on determining the UL data buffer is above the threshold value, a second UL transmission at a power value greater than the maximum transmit power.
S. The method as any of paragraphs A-R recite, the method further comprising transmitting reporting information indicating setting of the maximum transmit power based on the UE context.
T. The method as any of paragraphs A-S recite, wherein the UE is a 5G new radio (NR) UE.
U. A user equipment for wireless communication, comprising a memory storing computer-executable instructions; and at least one processor coupled with the memory and configured to execute the computer-executable instructions to perform the method of any of paragraphs A-T.
V. A user equipment for wireless communication, comprising means for performing the method of any of paragraphs A-T.
W. A non-transitory computer-readable medium storing computer executable code, the code when executed by a processor causes the processor to perform the method of any of paragraphs A-T.
X. A method of wireless communication at a base station, receiving, from a user equipment (UE) reporting information indicating setting of a maximum transmit power based on a UE context, and modifying, based on the receiving, one or more scheduling parameters associated with a DL grant allocated to the UE.
Y. The method as paragraph X recites, wherein the UE is a first UE, and the method further comprising transmitting, to a second UE, signaling enabling limiting of the maximum transmit power based on a UE context.
Z. The method as any of paragraphs X-Y recite, wherein the base station is a 5G new radio (NR) base station.
AA. A base station for wireless communication, comprising a memory storing computer-executable instructions; and at least one processor coupled with the memory and configured to execute the computer-executable instructions to perform the method of any of paragraphs X-Z.
AB. A base station for wireless communication, comprising means for performing the method of any of paragraphs X-Z.
AC. A non-transitory computer-readable medium storing computer executable code, the code when executed by a processor causes the processor to perform the method of any of paragraphs X-Z.

1. A method of wireless communication at a user equipment (UE), comprising:
determining whether a UE context is interference limited or noise limited based on comparing a measurement value to a threshold value;
setting a maximum transmit power based on the UE context; and
transmitting, during a time period associated with a downlink (DL) grant, an uplink (UL) transmission at the maximum transmit power.

2. The method of claim 1, wherein determining the UE context is interference limited or noise limited based on comparing the measurement value to the threshold value, comprises determining that the UE context is noise limited based upon the measurement value being less than the threshold value.

3. The method of claim 2, wherein setting the maximum transmit power based on the UE context, comprises determining the maximum transmit power based at least in part on UL and DL duplexer isolation of the UE.

4. The method of claim 2, wherein setting the maximum transmit power based on the UE context, comprises: determining the maximum transmit power based at least in part on UL configuration information associated with the UE.

5. The method of claim 2, wherein setting the maximum transmit power based on the UE context, comprises: determining the maximum transmit power based at least in part on an UL channel bandwidth of the UE.

6. The method of claim 2, wherein setting the maximum transmit power based on the UE context, comprises: determining the maximum transmit power based at least in part on a DL modulation scheme of the UE.

7. The method of claim 2, wherein the maximum transmit power is equal to or greater than 23 dBm.

8. The method of claim 1, wherein determining the UE context is interference limited or noise limited based on comparing the measurement value to the threshold value, comprises determining that the UE context is interference limited based upon the measurement value being equal to or greater than the threshold value.

9. The method of claim 8, wherein setting the maximum transmit power based on the UE context, comprises at least one of:
setting the maximum transmit power to a maximum value for power class two (PC2) or greater; or
setting the maximum transmit power to at least 26 dBm.

10. (canceled)

11. The method of claim 1, wherein determining the UE context is interference limited or noise limited based on comparing the measurement value to the threshold value, comprises:
performing a received signal strength indicator (RSSI) measurement to determine the measurement value; or
performing received signal strength indicator (RSSI) and reference signal received power (RSRP) measurements and combining the RSSI and RSRP measurements to determine the measurement value.

12. (canceled)

13. The method of claim 1, wherein the threshold value is a first threshold value, the measurement value is a first measurement value, and determining the UE context is interference limited or noise limited based on comparing the measurement value to the threshold value, comprises:
performing a received signal strength indicator (RSSI) measurement to determine the first measurement value;
performing a signal-to-interference-plus-noise ratio (SINR) measurement to determine a second measurement value;
comparing the first measurement value to the first threshold value; and
comparing the second measurement value to a second threshold value.

14. The method of claim 1, wherein the threshold value is a first threshold value, the measurement value is a first measurement value, and determining the UE context is interference limited or noise limited based on comparing the measurement value to the threshold value, comprises:
performing a received signal strength indicator (RSSI) measurement to determine the first measurement value;
performing a channel quality information (CQI) measurement to determine a second measurement value;
comparing the first measurement value to the first threshold value; and
comparing the second measurement value to a second threshold value.

15. The method of claim 1, wherein setting the maximum transmit power based on the UE context comprises:
determining that the DL grant is scheduled; and
setting the maximum transmit power for the UL transmission based on determining that the DL grant is scheduled.

16. The method of claim 1, wherein the UL transmission is a first UL transmission, and further comprising:
determining that a UL data buffer is above a threshold value; and
transmitting, based on determining the UL data buffer is above the threshold value, a second UL transmission at a power value greater than the maximum transmit power.

17. The method of claim 1, further comprising:
receiving, from a base station, signaling enabling setting of the maximum transmit power based on the UE context; or
transmitting reporting information indicating setting of the maximum transmit power based on the UE context.

18.-28. (canceled)

29. A user equipment (UE) for wireless communication, comprising:
one or more memories storing computer-executable instructions; and
one or more processors coupled with the one or more memories and configured to execute the computer-executable instructions, individually or in combination, to cause the user equipment to:
determine whether a UE context is interference limited or noise limited based on comparing a measurement value to a threshold value;
set a maximum transmit power based on the UE context; and
transmit, during a time period associated with a downlink (DL) grant, an uplink (UL) transmission at the maximum transmit power.

30. The UE of claim 29, wherein to determine the UE context is interference limited or noise limited based on comparing the measurement value to the threshold value, the one or more processors, individually or in combination, are configured to determine that the UE context is noise limited based upon the measurement value being less than the threshold value.

31. The UE of claim 30, wherein to set the maximum transmit power based on the UE context, the one or more processors, individually or in combination, are configured to determine the maximum transmit power based at least in part on UL and DL duplexer isolation of the UE.

32. The UE of claim 30, wherein to set the maximum transmit power based on the UE context, the one or more processors, individually or in combination, are configured to determine the maximum transmit power based at least in part on UL configuration information associated with the UE.

33. The UE of claim 30, wherein to set the maximum transmit power based on the UE context, the one or more processors, individually or in combination, are configured to determine the maximum transmit power based at least in part on an UL channel bandwidth of the UE.

34. The UE of claim 30, wherein to set the maximum transmit power based on the UE context, the one or more processors, individually or in combination, are configured to determine the maximum transmit power based at least in part on a DL modulation scheme of the UE.

35. The UE of claim 30, wherein the maximum transmit power is equal to or greater than 23 dBm.

36. The UE of claim 29, wherein to determine the UE context is interference limited or noise limited based on comparing the measurement value to the threshold value, the one or more processors, individually or in combination, are configured to determine that the UE context is interference limited based upon the measurement value being equal to or greater than the threshold value.

37. The UE of claim 38, wherein to set the maximum transmit power based on the UE context, the one or more processors, individually or in combination, are configured to:
set the maximum transmit power to a maximum value for power class two (PC2) or greater; or
set the maximum transmit power to at least 26 dBm.

38. The UE of claim 29, wherein to determine the UE context is interference limited or noise limited based on comparing the measurement value to the threshold value, the one or more processors, individually or in combination, are configured to:
perform a received signal strength indicator (RSSI) measurement to determine the measurement value; or
perform received signal strength indicator (RSSI) and reference signal received power (RSRP) measurements and combining the RSSI and RSRP measurements to determine the measurement value.

39. The UE of claim 29, wherein the threshold value is a first threshold value, the measurement value is a first measurement value, and to determine the UE context is interference limited or noise limited based on comparing the measurement value to the threshold value, the one or more processors, individually or in combination, are configured to:
perform a received signal strength indicator (RSSI) measurement to determine the first measurement value;
perform a signal-to-interference-plus-noise ratio (SINR) measurement to determine a second measurement value;
compare the first measurement value to the first threshold value; and
compare the second measurement value to a second threshold value.

40. The UE of claim 29, wherein the threshold value is a first threshold value, the measurement value is a first measurement value, and to determine the UE context is interference limited or noise limited based on comparing the measurement value to the threshold value, the one or more processors, individually or in combination, are configured to:
perform a received signal strength indicator (RSSI) measurement to determine the first measurement value;
perform a channel quality information (CQI) measurement to determine a second measurement value;
compare the first measurement value to the first threshold value; and
compare the second measurement value to a second threshold value.

41. The UE of claim 29, wherein to set the maximum transmit power based on the UE context, the one or more processors, individually or in combination, are configured to:
determine that the DL grant is scheduled; and
set the maximum transmit power for the UL transmission based on determining that the DL grant is scheduled.

42. The UE of claim 29, wherein the UL transmission is a first UL transmission, and the one or more processors, individually or in combination, are configured to:
determine that a UL data buffer is above a threshold value; and
transmit, based on determining the UL data buffer is above the threshold value, a second UL transmission at a power value greater than the maximum transmit power.

43. The UE of claim 29, wherein the one or more processors, individually or in combination, are configured to:
receive, from a base station, signaling enabling setting of the maximum transmit power based on the UE context; or
transmit reporting information indicating setting of the maximum transmit power based on the UE context.
